(19) United States
(12) Patent Application Publication
(10) Pub. No.: US 2021/0137657 A1
(43) Pub. Date: May 13, 2021

(54) Interdental Cleaning Device

(71) Applicant: Sylvia McPartland, Houston, TX (US)

(72) Inventor: Sylvia McPartland, Houston, TX (US)

(21) Appl. No.: 16/681,510

(22) Filed: Nov. 12, 2019

(51) Int. Cl. A61C 15/02

(52) U.S. Cl. CPC A61C 15/02

(57) ABSTRACT

A dental cleaner for use in cleaning dental furcations. The cleaner includes a handle having a generally central axis extending along the length thereof, wherein the handle comprises a bendable portion, a tip section, wherein the tip section comprises coarse foam, and a crimp, wherein the crimp connects the handle to the tip section.

### BACKGROUND

### 1. Field of Inventions

The field of this application and any resulting patent relates to an interdental cleaning device, and in particular, to a cleaning device having a configuration designed to access interdental spaces and furcations.

### 2. Description of Related Art

Various interdental cleaning devices have been proposed and utilized by dental professionals and nonprofessionals, including some of the interdental cleaning devices disclosed in the references appearing on the face of this patent. However, those interdental cleaning devices lack all the features of the interdental cleaning devices covered by any patent claims below. As will be apparent to a person of ordinary skill in the art, any interdental cleaning devices covered by claims of the issued patent solve many of the problems that prior art interdental cleaning devices have failed to solve. Also, the interdental cleaning devices covered by at least some of the claims of this patent have benefits that could be surprising and unexpected to a person of ordinary skill in the art based on the prior art existing at the time of invention.

### SUMMARY

One or more specific embodiments disclosed herein includes an interdental cleaner device for use in cleaning dental furcations comprising: a handle having a generally central axis extending along the length thereof, wherein the handle comprises a bendable portion; a tip section, wherein the tip section comprises coarse foam; and a crimp, wherein the crimp connects the handle to the tip section.

One or more specific embodiments disclosed herein includes an interdental cleaner device for use in cleaning dental furcations comprising: a handle having a generally central axis extending along the length thereof, wherein the handle comprises a bendable portion; a tip section, wherein the tip section comprises a tuft of coarse foam; and a crimp, wherein the crimp connects the handle to the tip section.

### BRIEF DESCRIPTION OF THE DRAWINGS

FIG. 1 is a perspective view of an embodiment of an interdental cleaning device.

FIG. 2 is a perspective view of an alternative embodiment of an interdental cleaning device.

FIG. 3 is a side view of an alternative embodiment of an interdental cleaning device with foam tufts on each end.

FIG. 4 is an illustration an embodiment of an interdental cleaning device in use.

FIG. 5 is an illustration an embodiment of an interdental cleaning device in use.

### DETAILED DESCRIPTION

### 1. Introduction

A detailed description will now be provided. The purpose of this detailed description, which includes the drawings, is to satisfy the statutory requirements of 35 U.S.C. § 112. For example, the detailed description includes a description of the inventions defined by the claims and sufficient information that would enable a person having ordinary skill in the art to make and use the inventions. In the figures, like elements are generally indicated by like reference numerals regardless of the view or figure in which the elements appear. The figures are intended to assist the description and to provide a visual representation of certain aspects of the subject matter described herein. The figures are not all necessarily drawn to scale, nor do they show all the structural details of the systems, nor do they limit the scope of the claims.

Each of the appended claims defines a separate invention which, for infringement purposes, is recognized as including equivalents of the various elements or limitations specified in the claims. Depending on the context, all references below to the “invention” may in some cases refer to certain specific embodiments only. In other cases, it will be recognized that references to the “invention” will refer to the subject matter recited in one or more, but not necessarily all, of the claims. Each of the inventions will now be described in greater detail below, including specific embodiments, versions, and examples, but the inventions are not limited to these specific embodiments, versions, or examples, which are included to enable a person having ordinary skill in the art to make and use the inventions when the information in this patent is combined with available information and technology. To the extent a term used in a claim is not defined below or in representations to the PTO, it should be given the broadest definition persons having skill in the art have given that term as reflected in any printed publication, dictionary, or issued patent.

### 2. Certain Specific Embodiments

Now, certain specific embodiments are described, which are by no means an exclusive description of the inventions. Other specific embodiments, including those referenced in the drawings, are encompassed by this application and any patent that issues therefrom.

One or more specific embodiments disclosed herein includes an interdental cleaner device for use in cleaning dental furcations comprising: a handle having a generally central axis extending along the length thereof, wherein the handle comprises a bendable portion; a tip section, wherein the tip section comprises coarse foam; and a crimp, wherein the crimp connects the handle to the tip section.

One or more specific embodiments disclosed herein includes an interdental cleaner device for use in cleaning dental furcations comprising: a handle having a generally central axis extending along the length thereof, wherein the handle comprises a bendable portion; a tip section, wherein the tip section comprises a tuft of coarse foam; and a crimp, wherein the crimp connects the handle to the tip section.

In any one of the instruments disclosed herein, the interdental cleaning device may comprise a handle, wherein the handle comprises ridges.

In any one of the instruments disclosed herein, the interdental cleaning device may comprise a handle, wherein the handle further comprises a toothpick end.

In any one of the instruments disclosed herein, the interdental cleaning device may comprise a handle, wherein the handle is made of plastic.

In any one of the instruments disclosed herein, the interdental cleaning device may comprise a coarse foam completely enveloping a tip section.

In any one of the instruments disclosed herein, the interdental cleaning device may comprise a coarse foam, wherein the coarse foam is pre-saturated with an antimicrobial solution.

### 3. Specific Embodiments in the Figures

The drawings presented herein are for illustrative purposes only and are not intended to limit the scope of the claims. Rather, the drawings are intended to help enable one having ordinary skill in the art to make and use the claimed inventions.

Referring to FIGS. 1-5, a specific embodiment, e.g., version or example, of an interdental cleaning device is illustrated. These figures may show features which may be found in various specific embodiments, including the embodiments shown in this specification and those not shown.

FIG. 1 shows a cleaning device 2. In embodiments, cleaning device 2 may comprise a handle 4, a tip section 6, and a crimp 8, which may connect the handle 4 to the tip section 6.

Still referring to FIG. 1, in embodiments the handle 4 may comprise a uniform cylindrical shape. Further, in embodiments, the handle 4 may be made of plastic. In embodiments, the diameter of the handle 4 may be about 0.125 in. In embodiments, the length of the handle may be about 3.350 in. Additionally, in embodiments, the handle 4 may have a bendable portion 10, which may be adjacent to the crimp 8. In embodiments, the bendable portion 10 may have a ribbed or knurled surface. Also, in embodiments, the bendable portion 10 may comprise embedded wire underneath the plastic exterior, wherein the embedded wire may allow for bending of the bendable potion 10. Further, in embodiments, the crimp 8 may comprise embedded wire underneath the plastic exterior for maintaining the shape due to any bending at the crimp 8. In embodiments, the ribbed or knurled surface of the bendable portion 10 may also assist with the bending of the bendable portion 10. In other embodiments, the end of the handle 4 farthest from the crimp 8 may comprise an additional tip section. Further, in these embodiments, a secondary crimp 14 (not illustrated) may be included about 0.555 in. from the end of the handle 4 farthest from the crimp 8. The secondary crimp 14 may allow for the changing of the angle of the additional tip section for use in cleaning. In alternative embodiments, the bendable portion 10 may be curved.

Remaining with FIG. 1, the tip section 6 may also be made of plastic in embodiments. In embodiments, surrounding the plastic of the tip section 6 may be a foam piece 12. In embodiments, the foam piece 12 may be coarse and porous. The foam piece 12 may envelope the entire tip section 6 in embodiments, and the foam piece 12 may also make a point at the tip of the foam piece 12 farthest from the crimp 8. Further, in embodiments, the diameter of the foam piece 12 may increase moving from the tip of the foam piece 12 farthest from the crimp 8 to the end of the foam piece 12 closest to the crimp 8. In embodiments, the foam piece 12 may be pre-saturated with a foaming antimicrobial substance. In other embodiments, the foam piece 12 may not be pre-saturated, in which case it may be dipped into a fluoride or antimicrobial solution. In other embodiments, the additional tip section may also have the foam piece 12.

In FIG. 1, the crimp 8 may be located about 0.542 in. from tip of the foam piece 12 farthest from the crimp 8 in embodiments. In embodiments, the crimp 8 may be made of plastic, and the crimp 8 may have a reduced diameter of about 0.090 in.

Alternatively, as shown in FIG. 2, the tip section 6 may comprise a foam tuft 16 at the end of the tip section 6 farthest from the crimp 8 in embodiments. The foam tuft 16 may be coarse and porous in embodiments. Further, in embodiments, the foam tuft 16 may be pre-saturated with a foaming antimicrobial substance. In other embodiments, the foam tuft 16 may not be pre-saturated, in which case it may be dipped into a fluoride or antimicrobial solution.

FIG. 3 illustrates an alternative embodiment of the cleaning device 2 in which both ends of handle 4 comprise crimps 8. Further, in the alternative embodiment, both ends of cleaning device 2 have tip sections 6, which each have foam tuft 16. FIGS. 4 and 5 depict the interdental cleaning device in use with teeth.

Generally, the above describes an improved interdental cleaning device. More specifically, the improved interdental cleaning device allows for improved cleaning of interdental spaces and furcations. A furcation is bone loss, which is usually the result of periodontal disease. The disease affects the base of the root trunk of the tooth where two or more roots meet (bifurcation or trifurcation).

What is claimed is:

1. A dental cleaner for use in cleaning dental furcations, comprising:
a handle having a generally central axis extending along the length thereof;
a tip section, wherein the tip section comprises coarse foam; and
a crimp, wherein the crimp connects the handle to the tip section.

2. The dental cleaner of claim 1, wherein the handle comprises ridges.

3. The dental cleaner of claim 1, wherein the handle further comprises a toothpick end.

4. The dental cleaner of claim 1, wherein the handle is made of plastic.

5. The dental cleaner of claim 1, wherein the coarse foam completely envelopes the tip section.

6. The dental cleaner of claim 5, wherein the coarse foam is pre-saturated with an antimicrobial solution.

7. The dental cleaner of claim 1, wherein the handle comprises a bendable portion.

8. The dental cleaner of claim 7, wherein the bendable portion of the handle comprises embedded wire.

9. A dental cleaner for use in cleaning furcations, comprising:
a handle having a generally central axis extending along the length thereof, wherein the handle comprises a bendable portion;
a tip section, wherein the tip section comprises a tuft of coarse foam; and
a crimp, wherein the crimp connects the handle to the tip section.

10. The dental cleaner of claim 9, wherein the handle comprises ridges.

11. The dental cleaner of claim 9, wherein the handle further comprises a toothpick end.

12. The dental cleaner of claim 9, wherein the handle is made of plastic.

13. The dental cleaner of claim 9, wherein the coarse foam is pre-saturated with an antimicrobial solution.

14. The dental cleaner of claim 9, wherein the bendable portion of the handle comprises embedded wire.
